(19) United States
(12) Patent Application Publication
(10) Pub. No.: US 2026/0074219 A1
(43) Pub. Date: Mar. 12, 2026

(54) CATHODE ACTIVE MATERIAL FOR LITHIUM SECONDARY BATTERIES, METHOD OF PREPARING SAME, CATHODE INCLUDING THE SAME, AND LITHIUM SECONDARY BATTERY INCLUDING CATHODE

(71) Applicant: Samsung SDI Co., Ltd., Yongin-si (KR)

(72) Inventors: Jangwook Lee, Yongin-si (KR); Wooyoung Yang, Yongin-si (KR); Ickkyu Choi, Yongin-si (KR)

(21) Appl. No.: 19/388,147

(22) Filed: Nov. 13, 2025

Related U.S. Application Data
(63) Continuation of application No. 17/820,420, filed on Aug. 17, 2022.

(30) Foreign Application Priority Data
Aug. 18, 2021 (KR) 10-2021-0108960

(51) Int. Cl. H01M 4/525; H01M 4/02; H01M 4/04; H01M 4/36

(52) U.S. Cl. CPC H01M 4/525; H01M 4/0404; H01M 4/366; H01M 2004/021

(57) ABSTRACT

A cathode active material for lithium secondary batteries, a method of preparing the same, a cathode including the same, and a lithium secondary battery including the cathode are provided. The cathode active material includes nickel-based lithium metal oxide secondary particles each including a plurality of large primary particles, the nickel-based lithium metal oxide secondary particles having a hollow structure having pores therein, each of the plurality of large primary particles having a size of about 2 μm to about 6 μm, and each of the nickel-based lithium metal oxide secondary particles having a size of about 10 μm to about 18 μm; and a cobalt compound-containing coating layer on surfaces of the nickel-based lithium metal oxide secondary particles.

### CROSS-REFERENCE TO RELATED APPLICATION

This application is a continuation of U.S. patent application Ser. No. 17/820,420 filed on Aug. 17, 2022, and claims priority to and the benefit of Korean Patent Application No. 10-2021-0108960, filed on Aug. 18, 2021, in the Korean Intellectual Property Office, the entire content of each of which is incorporated by reference herein.

### BACKGROUND

### 1. Field

One or more embodiments relate to a cathode active material for lithium secondary batteries, a method of preparing the same, a cathode including the same, and a lithium secondary battery including the cathode.

### 2. Description of the Related Art

With the advance of portable electronic devices and communication devices, the desire or need for the development of lithium secondary batteries having high energy density is great or high. However, a lithium secondary battery having high energy density may have poor safety, and thus improvement in this regard is desired or required.

In order to manufacture a lithium secondary battery with a long lifespan and reduced gas, the use of a single-crystal cathode active material as a cathode active material for a lithium secondary battery is being examined. A single-crystal cathode active material has a problem in that particle aggregation occurs or productivity is reduced due to heat treatment at a high temperature for single crystallization.

In order to solve the particle aggregation of single-crystal cathode active materials, a pulverization process is performed when a single-crystal cathode active material is utilized. However, when a pulverization process is performed in this way, crystallinity of the cathode active material deteriorates, surface defects thereof occur, and residual pulverized materials thereof are produced as impurities, and thus improvement in this regard is desired or required.

### SUMMARY

Aspects of one or more embodiments are directed toward a cathode active material for lithium secondary batteries in which aggregation between particles is suppressed or reduced and a cation mixing ratio is reduced.

Aspects of one or more embodiments are directed toward a method of preparing the cathode active material.

Aspects of one or more embodiments are directed toward a cathode including the cathode active material.

Aspects of one or more embodiments are directed toward a lithium secondary battery including the cathode.

Additional aspects will be set forth in part in the description that follows and, in part, will be apparent from the description, or may be learned by practice of the presented embodiments of the disclosure.

One or more embodiments provide a cathode active material for lithium secondary batteries, the cathode active material including: nickel-based lithium metal oxide secondary particles each including a plurality of single-crystal (or large) primary particles, the nickel-based lithium metal oxide secondary particles having a hollow structure having pores therein, the plurality of single-crystal (or large) primary particles having a size (average size) of about 2 μm to about 6 μμm, and the nickel-based lithium metal oxide secondary particles having a size (average size) of about 10 μμm to about 18 μμm; and a cobalt compound-containing coating layer on surfaces of the nickel-based lithium metal oxide secondary particles.

One or more embodiments provide a method of preparing a cathode active material for lithium secondary batteries, the method including: mixing a nickel precursor, at least one of an M1 precursor or an M2 precursor (e.g., one selected from an M1 precursor and an M2 precursor), and a basic solution to obtain a mixture, subjecting the mixture to a co-precipitation reaction, and then drying the mixture to obtain a nickel-based metal precursor having pores therein; obtaining a mixture of the nickel-based metal precursor having pores therein and a lithium precursor; performing a primary heat treatment of the mixture to obtain a product of the primary heat treatment; and adding a cobalt precursor to the product of the primary heat treatment without a pulverization process of the product to obtain a mixture, and performing a secondary heat treatment of the mixture to prepare the above-described cathode active material, wherein the primary heat treatment is performed at a higher temperature than the secondary heat treatment, the M1 precursor is at least one of a cobalt precursor, a manganese precursor, or an aluminum precursor (e.g., one selected from a cobalt precursor, a manganese precursor, and an aluminum precursor), and the M2 precursor contains at least one of boron (B), magnesium (Mg), calcium (Ca), strontium (Sr), barium (Ba), titanium (Ti), vanadium (V), chromium (Cr), iron (Fe), copper (Cu), or zirconium (Zr) (e.g., one element selected from boron (B), magnesium (Mg), calcium (Ca), strontium (Sr), barium (Ba), titanium (Ti), vanadium (V), chromium (Cr), iron (Fe), copper (Cu), and zirconium (Zr)).

One or more embodiments provide a cathode for lithium secondary batteries, the cathode including: a cathode current collector; and a cathode active material layer on the cathode current collector, wherein the cathode active material layer includes the above-described cathode active material, and at least one of large (e.g. single-crystal single) particles or aggregates thereof (e.g., one selected from large (e.g. single-crystal) particles and aggregates thereof), the single-crystal single (large) particles having the same composition as the cathode active material. One or more embodiments provide a lithium secondary battery including: the above-described cathode; an anode; and an electrolyte between the cathode and the anode.

### BRIEF DESCRIPTION OF THE DRAWINGS

The above and other aspects, features, and/or principles of embodiments of the disclosure will be more apparent from the following description taken in conjunction with the accompanying drawings, in which:

FIG. 1A is a scanning electron microscope (SEM) image of a cross-section of a cathode active material prepared according to Example 1;

FIG. 1B is a schematic diagram illustrating the structure of a hollow cathode active material having a one-layer structure according to one or more embodiments of the present disclosure;

FIG. 1C is a schematic diagram illustrating the structure of a hollow cathode active material having a two-layer structure according to one or more embodiments of the present disclosure;

FIG. 2A is a scanning electron microscope image of a cross-section of a cathode active material prepared according to Comparative Example 2;

FIG. 2B is a scanning electron microscope image of a cross-section of a cathode active material prepared according to Comparative Example 4;

FIG. 2C is a scanning electron microscope image of a cross-section of a nickel-based metal precursor prepared according to Preparation Example 1;

FIG. 2D is a scanning electron microscope image of a cross-section of a nickel-based metal precursor prepared according to Comparative Preparation Example 1;

FIGS. 3A and 3B are images each illustrating a state before pressing is performed when manufacturing a cathode according to Manufacturing Example 1;

FIG. 3C is an image illustrating a state after pressing is performed when manufacturing a cathode according to Manufacturing Example 1;

FIG. 3D is an image illustrating a state after pressing is performed when manufacturing a cathode according to Comparative Manufacturing Example 4;

FIG. 4 is a schematic perspective view of a lithium secondary battery according to one or more embodiments of the present disclosure;

FIG. 5 is an image illustrating the results of energy-dispersive spectroscopy (EDS) of a cathode active material of Example 1, in which the concentration distribution of cobalt ions in the cathode active material was measured by energy-dispersive spectroscopy (EDS); and

FIG. 6 is an image illustrating the results of energy-dispersive spectroscopy analysis of a cathode active material of Comparative Example 1.

### DETAILED DESCRIPTION

Reference will now be made in more detail to embodiments, examples of which are illustrated in the accompanying drawings, wherein like reference numerals refer to like elements throughout, and duplicative descriptions thereof may not be provided. In this regard, the present embodiments may have different forms and should not be construed as being limited to the descriptions set forth herein. Accordingly, the embodiments are merely described, by referring to the drawings, to explain aspects of the present description. These embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. In the drawings, the relative sizes of elements, layers, and regions may be exaggerated for clarity.

As utilized herein, the term “and/or” includes any and all combinations of one or more of the associated listed items. Expressions such as “at least one of,” when preceding a list of elements, modify the entire list of elements and do not modify the individual elements of the list. Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section.

Thus, a first element, component, region, layer or section described below could be termed a second element, component, region, layer or section, without departing from the spirit and scope of the present disclosure.

It will be understood that when an element or layer is referred to as being “on,” another element or layer, it can be directly on the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, a cathode active material for lithium secondary batteries according to one or more embodiments, a preparation method thereof, a cathode including the same, and a lithium secondary battery including the cathode will be described in more detail.

In order to manufacture a lithium secondary battery having improved lifespan characteristics, a cathode containing a single-crystal cathode active material is utilized. Single-crystal cathode active material undergoes a process of high-temperature heat treatment by injecting an excessive amount of lithium during manufacturing. In this case, due to high-temperature heat treatment, particles aggregate or productivity decreases and residual lithium increases. In one or more embodiments, when a lithium secondary battery is manufactured utilizing such a single-crystal cathode active material, capacity and charging/discharging efficiency are reduced.

In the single-crystal cathode active material, particle aggregation occurs, so that a pulverization process should be performed when manufacturing a cathode. After such a pulverization process, single-crystal properties of the cathode active material are deteriorated, residual pulverized products are generated, and surface resistance thereof becomes high, so improvements thereof are required.

Accordingly, the present inventors have completed the present disclosure for a one-body particle (e.g., individual, separate particles) cathode active material having improved surface resistance properties, which does not require a pulverization process because particle aggregation does not occur, solving the above problems.

A cathode active material for lithium secondary batteries according to one or more embodiments includes: nickel-based lithium metal oxide secondary particles each including a plurality of large primary particles, the secondary particles having a hollow structure having pores therein, the large primary particles having (e.g., each of the large primary particles having) a size of about 2 μμm to about 6 μm, and the secondary particles (i.e., the nickel-based lithium metal oxide secondary particles) having (e.g., each of the secondary particles having) a size of about 10 μm to about 18 μm; and a cobalt compound-containing coating layer arranged on surfaces of the nickel-based lithium metal oxide secondary particles.

In the present specification, when particles are spherical, “size” indicates an average particle diameter, and when the particles are non-spherical, the “size” indicates a major axis length (e.g., an average major axis length). The size of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

When the cathode active material includes a cobalt compound-containing coating layer, surface resistance characteristics are improved. A, lithium secondary battery including a cathode utilizing the same has improved lifespan characteristics.

In the cathode active material according to one or more embodiments, the secondary particles may include a large primary particle layer within two layers.

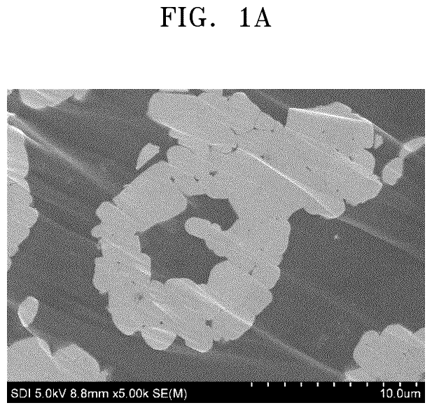

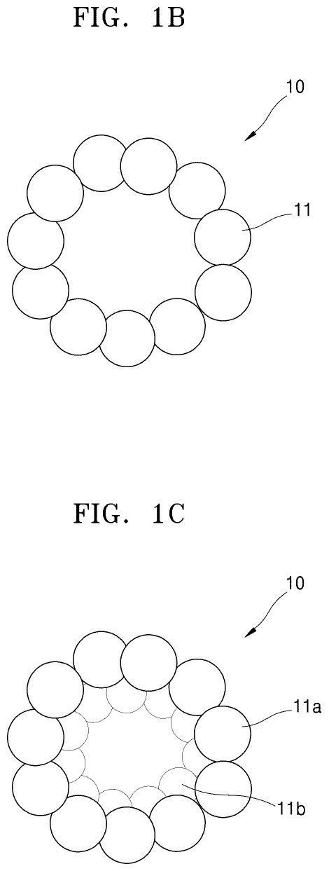

The cathode active material 10 according to one or more embodiments is a secondary particle, and as shown in FIG. 1B, includes a hollow large primary particle layer having a single-layer structure. The hollow large primary particle layer contains primary particles 11.

As shown in FIG. 1C, the cathode active material 10 according to one or more embodiments includes a hollow large primary particle layer having a two-layer structure. Due to such a structure, a breaking process may be easily performed during pressing. In FIG. 1C, reference numerals 11a and 11b denote first primary particles and second primary particles, respectively, which respectively form a primary particle layer arranged on the first layer and a primary particle layer arranged on the second layer.

The cathode active material according to one or more embodiments has a cluster structure that is easily broken by pressing for manufacturing a cathode, and thus does not require a pulverization process. When such a cathode active material is utilized, a cathode having a form in which a conductive agent and a binder are continuously connected in a cathode plate may be manufactured.

The cathode active material according to one or more embodiments may include a plurality of large primary particles that are partially broken during a pressing process, and secondary particles each being an aggregate of the primary particles.

In the cathode active material according to one or more embodiments, the size of the primary particles is, about 2 μm to about 6 μm, for example, about 2 μm to about 4 μm, or about 2 μm to about 3.5 μm, and the size of the secondary particles is, about 10 μm to about 18 μm, for example, about 12 μm to about 18 μm, or about 12 μm to about 14 μm. In some embodiments, the size of pores inside the cathode active material is about 2 μm to about 7 μm, about 2 μm to about 5 μm, or about 2.5 μm to about 4 μm When the size of the primary particles, the size of the secondary particles, and the size of the pores are within the above ranges, respectively, a cathode active material having excellent or suitable capacity characteristics may be obtained. As used herein, the size of pores may be measured using mercury intrusion method, gas adsorption method such as BET (Brunauer, Emmett and Teller) or BJH (Barrett-Joyner-Halenda), SEM, or the like, and the term “the size of pores” may mean average pore size.

For pore size analysis, mercury intrusion method or gas adsorption method is mainly used, and the generally known pore measurement method is used. The measurement by SEM uses image analysis. For pore size analysis of the embodiment, a gas adsorption method such as BET (Brunauer, Emmett, Teller) was used.

As utilized herein, the term “inside” of the cathode active material refers to a region of 50 vol % to 70 vol %, for example, 60 vol % of the total volume from the center of the cathode active material to the surface of the cathode active material, or refers to a remaining region excluding the region (outside) within 3 μm from the outermost surface of the cathode active material in the total distance from the center of the cathode active material to the surface of the cathode active material.

In the cathode active material according to one or more embodiments, a cobalt compound-containing coating layer is formed on at least one of the surfaces or grain boundaries of the plurality of primary particles.

The cobalt compound-containing coating layer may coat all or part of the surface of the cathode active material. For example, the coating layer may coat 90% or less, 80% or less, 70% or less, 60% or less, 50% or less, 40% or less, 30% or less, 20% or less, 10% or less, or 1% to 10% of the surface of the cathode active material.

The content (e.g., amount) of a cobalt compound in the coating lay may be 0.1 mol % to 5.0 mol %, 0.5 mol % to 5.0 mol %, 1 mol % to 4 mol %, or 1.5 mol % to 3 mol % based on the total content (e.g., amount) (100 mol %) of the cathode active material. When the content (e.g., amount) of the cobalt compound is within the above range, in the synthesis process of the cathode active material, the reactivity between an electrolyte and the interface of the cathode active material may be decreased by reducing Ni³⁺ included in a metal layer in a large amount into Ni²⁺ and Co⁴⁺ included in the metal layer in a large amount into Co³⁺/Co²⁺ or reducing the two types (kinds) of ions at the same time.

The cobalt compound-containing coating layer includes cobalt oxide, lithium cobalt oxide, or a combination thereof. In some embodiments, the cobalt compound-containing coating layer may further include at least one of boron, manganese, phosphorus, aluminum, zinc, zirconium, or titanium (e.g., one selected from boron, manganese, phosphorus, aluminum, zinc, zirconium, and titanium).

The coating layer has a thickness of about 1 nm to about 50 nm, about 5 nm to about 45 nm, or about 10 nm to about 35 nm. When the thickness of the coating layer is within the above range a cathode active material having improved surface resistance characteristics may be obtained.

The nickel-based lithium metal oxide is a compound represented by Formula 1.

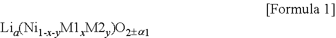

in Formula 1, M1 is at least one of (e.g., one element selected from) Co, Mn, or Al,

M2 is at least one of boron (B), magnesium (Mg), calcium (Ca), strontium (Sr), barium (Ba), titanium (Ti), vanadium (V), chromium (Cr), iron (Fe), copper (Cu), or zirconium (Zr) (e.g., one element selected from boron (B), magnesium (Mg), calcium (Ca), strontium (Sr), barium (Ba), titanium (Ti), vanadium (V), chromium (Cr), iron (Fe), copper (Cu), and zirconium (Zr)),

0.95≤a≤1.1, 0.6≤(1−x−y)<1, 0≤x<0.4, 0≤y<0.4, and 0≤α1≤0.1 are satisfied, and the case where both (e.g., simultaneously) x and y are 0 is excluded.

The nickel-based lithium metal oxide is, for example, a compound represented by Formula 2.

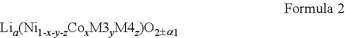

In Formula 2, M3 is at least one of Mn or Al (e.g., one element selected from Mn and Al), M4 is at least one of boron (B), magnesium (Mg), calcium (Ca), strontium (Sr), barium (Ba), titanium (Ti), vanadium (V), chromium (Cr), iron (Fe), copper (Cu), or zirconium (Zr) (e.g., one element selected from boron (B), magnesium (Mg), calcium (Ca), strontium (Sr), barium (Ba), titanium (Ti), vanadium (V), chromium (Cr), iron (Fe), copper (Cu), and zirconium (Zr)), 0.95≤a≤1.1, 0.6≤(1−x−y−z)<1, 0≤x<0.4, 0≤y<0.4, 0≤z<0.4, and 0≤α1≤0.1 are satisfied, and the case where all of x, y, and z are 0 is excluded.

The expression “the case where all of x, y, and z are 0” represents “the case where x, y, and z are all 0”.

The peak intensity ratio (I(003)/I(104)) of the cathode active material according to one or more embodiments, measured by X-ray diffraction analysis utilizing Cu Kα radiation (1.54056 Å), is about 1.2 to about 4.0, about 1.2 to about 2.0, about 1.3 to about 1.8, about 1.3 to about 1.6, or about 1.3 to about 1.4. When the peak intensity ratio (I(003)/I(104)) is within the above range, the stability of the crystal structure of the cathode active material may be improved.

According to one or more embodiments, in the case of a cathode active material having a nickel content (e.g., amount) of 88 mol % based on the total amount of metals other than lithium, the peak intensity ratio (I(003)/I(104)) thereof is about 1.2 to about 1.4, and in the case of a cathode active material having a nickel content (e.g., amount) of 93 mol % (based on the total amount of metals other than lithium), the peak intensity ratio (I(003)/I(104)) thereof is about 1.3 to about 2.0.

When the peak intensity ratios I(003)/I(104) of the cathode active material and the electrode plate including the cathode active material are within the above ranges, the stability of the crystal structure of the cathode active material is improved, and the expansion rate and contraction rate of the cathode active material according to the absorption/desorption of lithium may be improved. Accordingly, the capacity characteristics of a battery may be improved.

In the X-ray diffraction analysis, the peak intensities (003) and I(104) refer to the intensity I(003) of the (003) plane peak and the intensity I(104) of the (104) plane peak, respectively. In some embodiments, the peak intensity ratio I(003)/I(104), which is an intensity ratio of the (003) plane peak and the (104) plane peak, is a parameter made to evaluate the degree of substantially uniform orientation of grains, and may evaluate the degree of cation mixing or cation exchange. For example, the (104) plane represents a plane perpendicular to the plane of a lithium-ion movement path. In one or more embodiments, as the degree of orientation of a crystal plane having a layered structure increases, the peak intensity of the (104) plane decreases. Accordingly, the higher the orientation, the more the same crystal orientation plane increases, so the peak intensity of the (104) plane decreases, and thus the peak intensity ratio I(003)/I(104) increases. For example, it means that as the peak intensity ratio I(003)/I(104) increases, a stable cathode active material structure is formed.

The area ratio (A(003)/A(104)) of the area of the (003) plane peak to the area of the (104) plane peak, measured by X-ray diffraction analysis of the cathode active material according to one or more embodiments, is about 1.1 to about 1.4, about 1.12 to about 1.38, about 1.15 to about 1.35, or about 1.2 to about 1.3.

When measuring the peak intensity ratio I(003)/I(104) by X-ray diffraction analysis for a cathode according to one or more embodiments, the peak intensity ratio is equal to the peak intensity ratio I(003)/I(104) measured by X-ray diffraction analysis for the cathode active material contained in the cathode.

The cathode active material of the present disclosure has a FWHM₍₀₀₃₎ of 0.079° to 0.082°, for example, 0.081°, and a ratio of FWHM₍₀₀₃₎/FWHM₍₁₀₄₎ of 0.800 to 0.900, for example, 0.850. Thus, it may be found that the cathode active material is a crystal material. Here, FWHM₍₀₀₃₎ represents a full width at half maximum (FWHM) of a peak corresponding to the (003) plane, and FWHM₍₁₀₄₎ represents a full width at half maximum of the peak corresponding to the (104) plane.

In some embodiments, it may be found that the cathode active material according to one or more embodiments is a crystal material by checking grains and grain boundaries of a sub-micro scale or higher when cross-sectional microstructures are observed through an electron scanning microscope.

When the area ratio (A(003)/A(104)) and peak intensity ratio I (003)/I (104) of the cathode active material and the electrode plate including the cathode active material are within the above ranges, the stability of the crystal structure of the cathode active material is improved, and the expansion rate and contraction rate of the cathode active material according to the absorption/desorption of lithium may be improved. Accordingly, the capacity characteristics of a battery may be improved.

Hereinafter, a method of preparing a cathode active material according to one or more embodiments will be described.

First, a mixture obtained by mixing a nickel precursor, at least one of (e.g., one metal precursor selected from) an M1 precursor and an M2 precursor, and a basic solution is subjected to a co-precipitation reaction, and then dried to obtain a nickel-based metal precursor having pores therein. The nickel-based metal precursor has amorphous properties.

The M1 precursor is the same as M1 of Formula 1, and is at least one of (e.g., one selected from) a cobalt precursor, a manganese precursor, and an aluminium precursor. In some embodiments, the M2 precursor is the same as M2 of Formula 1, and is a precursor containing at least one of boron (B), magnesium (Mg), calcium (Ca), strontium (Sr), barium (Ba), titanium (Ti), vanadium (V), chromium (Cr), iron (Fe), copper (Cu), or zirconium (Zr) (e.g., one element selected from boron (B), magnesium (Mg), calcium (Ca), strontium (Sr), barium (Ba), titanium (Ti), vanadium (V), chromium (Cr), iron (Fe), copper (Cu), and zirconium (Zr)).

The metal precursor may be, for example, at least one of a nickel precursor, a cobalt precursor, a manganese precursor, or the M2 metal precursor (e.g., one selected from a nickel precursor, a cobalt precursor, a manganese precursor, and the M2 metal precursor).

During the co-precipitation reaction, the pH of the mixture is adjusted in two steps. The first step is a pore formation step, and the pH of the mixture is adjusted to 11.5 to 12.0. The second step is a particle growth step, and the pH of the mixture is adjusted to, for example, 10.5 to 11.9. The second step is carried out at a lower pH than the first step. A difference in synthesis rate between the inside and outside of the nickel-based metal precursor is caused by changing a co-precipitation rate in this way.

As a result, a nickel-based metal precursor having pores therein may be obtained. Here, the nickel-based metal precursor refers to a precursor for obtaining a nickel-based lithium metal oxide.

In the first step, for example, the pH of the mixture is adjusted to 11.6 to 11.9 or 11.7 to 11.8. In the second step, for example, the pH of the mixture is adjusted in the range of 10.8 to 11.7, 11.0 to 11.7, 11.2 to 11.6, or 11.3 to 11.6. A difference in pH between the first step and the second step is about 0.1 to 1.5, 0.1 to 1.0, 0.1 to 0.8, 0.1 to 0.6, 0.1 to 0.5, 0.1 to 0.3, or 0.1 to 0.2. As such, by reducing the pH of the mixture in the second step to the above-described difference compared to the pH of the mixture in the first step, the co-precipitation rate is changed, thereby generating a difference in synthesis rate between the inside and outside of the nickel-based metal precursor. As a result, a nickel-based metal precursor having pores therein may be obtained. Here, the nickel-based metal precursor refers to a precursor for obtaining a nickel-based lithium metal oxide.

The stirring time of the mixture in the first step may be changed depending on the pH conditions of the first step, but is, for example, in the range of 8 hours to 12 hours or 9 hours to 10 hours.

In the present disclosure, the above-described co-precipitation reaction proceeds at a faster rate than that in a general method of preparing a cathode active material precursor, so that the pore dispersion of a core is controlled or selected high, and thus a cathode active material may be easily manufactured without performing a separate pulverization process for the cathode active material, thereby improving productivity. When pore dispersion is controlled or selected to be high, an active material has more pores after heat treatment, so that the active material is easily broken during pressing, so that a cathode including the active material has excellent or suitable electrochemical properties. Here, it is possible to perform the co-precipitation at a high speed by adjusting stirring time to be short while stirring speed is fast.

The metal precursor having pores therein, like the cathode active material, includes secondary particles each containing a plurality of primary particles, and has a hollow structure having pores therein. The secondary particles have a size of about 10 μm to about 18 μm. The primary particles have a size of about 0.2 μm to about 0.3 μm. The above-described nickel-based metal precursor having pores therein

exhibits amorphous characteristics, and includes an inside having pores and an outside having a denser structure than the interior. The amorphous characteristics of the nickel-based metal precursor may be confirmed by X-ray diffraction analysis.

As utilized herein, the “inside” of the nickel-based metal precursor refers to a pore region in which a large number of pores exist, and refers to a region of 50 vol % to 70 vol %, for example, 60 vol % from the center of the total volume from the center of the precursor to the surface of the precursor, or a remaining region except for the region (outside) within 3 μm from the outermost surface of the cathode active material in the total distance from the center of the precursor to the surface of the precursor.

According to one or more embodiments, the inside of the nickel-based metal precursor is a pore region, and represents a region having a major axis length of about 2 μm to about 7 μm, for example, about 3.5 μm to about 5 μm.

In the metal precursor having pores therein, the size of the pore region is about 2 μm to about 7 μm, and the size of the secondary particles is about 10 □m to about 18 □m, about 10 μm to about 15 μm, or about 11 μm to about 14 μm When the size of the pore region of the metal precursor and the size of the secondary particles are within the above ranges, respectively, a cathode active material having excellent or suitable phase stability and improved capacity characteristics may be obtained.

The mixture may include a complexing agent, a pH adjuster, and/or the like.

The pH adjuster serves to lower the solubility of metal ions in a reactor such that the metal ions are precipitated as hydroxides. The pH adjuster is, for example, ammonium hydroxide, sodium hydroxide (NaOH), sodium carbonate (Na₂CO₃), and/or any other suitable pH adjuster. The pH adjuster is, for example, sodium hydroxide (NaOH).

The complexing agent serves to control the formation rate of precipitates in the co-precipitation reaction. The complexing agent is, for example, ammonium hydroxide (NH₄OH) (ammonia water), citric acid, acrylic acid, tartaric acid, glycolic acid, and/or any other suitable complexing agent. The content of the complexing agent may be used at any suitable amount generally used in the art for complexing agents. The complexing agent is, for example, ammonia water.

A desired or suitable nickel-based precursor may be obtained by washing and drying the product obtained according to the co-precipitation reaction. Here, the drying is carried out under suitable conditions known to those skilled in the art.

The above-described nickel precursor and at least one of (e.g., one metal precursor selected from) the M1 precursor and the M2 precursor include, for example, a nickel precursor, a manganese precursor, and/or a cobalt precursor. In one or more embodiments, the metal precursor includes, for example, a nickel precursor, a cobalt precursor, and/or an aluminum precursor.

Examples of the nickel precursor may include Ni(OH)₂, NiO, NiOOH, NiCO₃·2Ni(OH)₂·4H₂O, NiC₂O₄·2H₂O, Ni(NO₃)₂·6H₂O, NiSO₄, NiSO₄·6H₂O, fatty acid nickel salts, nickel halide, and combinations thereof. Examples of the manganese precursor may include manganese oxides such as Mn₂O₃, MnO₂, and/or Mn₃O₄, manganese salts such as MnCO₃, Mn(NO₃)₂, MnSO₄, MnSO₄·H₂O, manganese acetate, manganese dicarboxylate, manganese citrate, and/or fatty acid manganese salts, manganese oxyhydroxide, manganese and/or halides such as manganese chloride, and combinations thereof.

Examples of the cobalt precursor may include Co(OH)₂, CoOOH, CoO, Co₂O₃, Co₃O₄, Co(OCOCH₃)₂·4H₂O, CoCl₂, Co(NO₃)₂·6H₂O, CoSO₄, CO(SO₄)₂·7H₂O, and combinations thereof.

Examples of the aluminium precursor may include aluminum hydroxide, aluminum chloride, aluminium oxide, and combinations thereof.

In the above-described M2 precursor, the precursor containing each element may be a salt, hydroxide, oxyhydroxide, halide, each containing each element, or a combination thereof. Here, the above-described salt containing each element may include at least one of (e.g., one selected from) sulfate, alkoxide, oxalate, phosphate, halide, oxyhalide, sulfide, oxide, peroxide, acetate, nitrate, carbonate, citrate, phthalate, and/or perchlorate, each containing the above-described element.

The content (e.g., amount) of the nickel precursor and the content (e.g., amount) of at least one of (e.g., one metal precursor selected from) the M1 precursor and/or the M2 precursor are stoichiometrically controlled or selected so that the desired or suitable nickel-based metal precursor is obtained.

The nickel-based metal precursor is a compound represented by Formula 3, a compound represented by Formula 4, or a combination thereof.

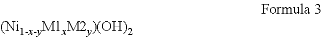

In Formula 3, M1 is at least one of (e.g., one element selected from) Co, Mn, and/or Al, M2 is at least one of (e.g., one element selected from) boron (B), magnesium (Mg), calcium (Ca), strontium (Sr), barium (Ba), titanium (Ti), vanadium (V), chromium (Cr), iron (Fe), copper (Cu), and/or zirconium (Zr), and 0.6≤(1−x−y)<1, 0≤x<0.4, and 0≤y<0.4 are satisfied, and a case where both x and y are 0 is excluded.

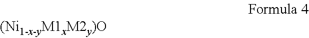

In Formula 4, M1 is at least one of (e.g., one element selected from) Co, Mn, and/or Al, M2 is at least one of (e.g., one element selected from) boron (B), magnesium (Mg), calcium (Ca), strontium (Sr), barium (Ba), titanium (Ti), vanadium (V), chromium (Cr), iron (Fe), copper (Cu), and/or zirconium (Zr), and 0.6≤(1−x−y)<1, 0≤x<0.4, and 0≤y<0.4 are satisfied, and a case where both x and y are 0 is excluded.

The nickel-based metal precursor is, for example, a compound represented by Formula 5, a compound represented by Formula 6, or a combination thereof.

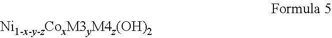

In Formula 5, M3 is at least one of (e.g., one element selected from) Mn, and/or Al, M4 is at least one of (e.g., one element selected from) boron (B), magnesium (Mg), calcium (Ca), strontium (Sr), barium (Ba), titanium (Ti), vanadium (V), chromium (Cr), iron (Fe), copper (Cu), and/or zirconium (Zr), and 0.6≤(1−x−y−z)<1, 0≤x<0.4, 0≤y<0.4, and 0≤z<0.4 are satisfied, and a case where all of x, y, and z are 0 is excluded.

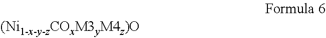

In Formula 6, M3 is at least one of (e.g., one element selected from) Mn, and/or Al, M4 is at least one of (e.g., one element selected from) boron (B), magnesium (Mg), calcium (Ca), strontium (Sr), barium (Ba), titanium (Ti), vanadium (V), chromium (Cr), iron (Fe), copper (Cu), and/or zirconium (Zr), and 0.6≤(1−x−y−z)<1, 0≤x<0.4, 0≤y<0.4, and 0≤z<0.4 are satisfied, and a case where all of x, y, and z are 0 is excluded.

The nickel-based metal precursor is, for example, a compound represented by Formula 7, a compound represented by Formula 8, or a combination thereof.

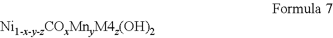

In Formula 7, M4 is at least one of (e.g., one element selected from) boron (B), magnesium (Mg), calcium (Ca), strontium (Sr), barium (Ba), titanium (Ti), vanadium (V), chromium (Cr), iron (Fe), copper (Cu), and/or zirconium (Zr), and 0.6<(1−x−y−z)<1, 0≤x<0.4, 0≤y<0.4, and 0≤z<0.4 are satisfied, and a case where all of x, y, and z are 0 is excluded.

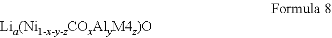

In Formula 8, M4 is at least one of (e.g., one element selected from) boron (B), magnesium (Mg), calcium (Ca), strontium (Sr), barium (Ba), titanium (Ti), vanadium (V), chromium (Cr), iron (Fe), copper (Cu), and/or zirconium (Zr), and 0.6≤(1−x−y−z)<1, 0≤x<0.4, 0≤y<0.4, and 0≤z<0.4 are satisfied, and a case where all of x, y, and z are 0 is excluded.

Then, a mixture of the nickel-based metal precursor having pores therein and the lithium precursor is obtained.

The mixing ratio of the lithium precursor and the nickel-based metal precursor is stoichiometrically adjusted so as to prepare a desired or suitable cathode active material. Primary heat treatment of the mixture is performed. Phase transition and grain growth proceed through the primary heat treatment to prepare a primary heat-treated product.

A cobalt precursor is added to the primary heat-treated product without a pulverization process of the product to obtain a mixture. The cobalt precursor is utilized when forming a cobalt compound-containing coating layer on the surface of the nickel-based lithium metal oxide.

As utilized herein, the “pulverization” proceeds utilizing equipment such as a jet mill that applies a strong force (pneumatic pressure, mechanical pressure, and/or the like) to remove the strong aggregation of the primary particles constituting the secondary particle.

Secondary heat treatment is performed on the mixture obtained according to the above process to prepare a cathode active material according to one or more embodiments.

The secondary heat treatment is performed at a lower temperature than the primary heat treatment, and crystallinity is recovered when the secondary heat treatment is performed. When the secondary heat treatment is performed at a higher temperature than the first heat treatment, it is difficult to obtain a large particle having excellent or suitable phase stability. In one or more embodiments, in the manufacturing method, when the primary heat-treated product is subjected to a pulverization process, it is difficult to obtain a cathode active material having a hollow structure.

The nickel-based metal precursor and the lithium precursor may be mixed such that a molar ratio of Li/Me (where Me is, e.g., an element other than Li, O, and H) is 0.9 or more and less than 1.1, more than 1.0 and less than 1.1, 1.01 to 1.05, or 1.02 to 1.04. The mixing process of the nickel-based metal precursor and the lithium precursor may be carried out by two processes, not one process. For example, in the first mixing, the amount of the nickel-based metal precursor and the lithium precursor may be controlled or selected such that the molar ratio of Li/Me (where Me is, e.g., an element other than Li, O, and H) is 0.9, and in the second mixing, the amount of the nickel-based metal precursor and the lithium precursor may be controlled or selected such that the molar ratio of Li/Me (where Me is, e.g., a metal other than Li) is 0.5.

The lithium precursor may be, for example, lithium hydroxide, lithium carbonate, lithium sulfate, lithium nitrate, or a combination thereof.

The primary heat treatment is performed at a temperature of 800° C. to 1200° C., 830° C. to 1150° C., 850° C. to 1100° C., 850° C. to 950° C., or 870° C. to 920° C. under an oxidizing gas atmosphere, and the secondary heat treatment is performed at a temperature of 600° C. to 850° C., 600° C. to 800° C., 650° C. to 800° C., 700° C. to 800° C., or 720° C. to 790° C. under an oxidizing gas atmosphere. When the primary heat treatment and the secondary heat treatment are performed under the above conditions, a high-density and long-lifespan lithium secondary battery may be manufactured.

The primary heat treatment time is changed depending on the primary heat treatment temperature, for example, the primary heat treatment is carried out for about 8 hours to about 20 hours.

The oxidizing gas atmosphere uses an oxidizing gas such as oxygen or air, for example, the oxidizing gas includes 10 vol % to 20 vol % of oxygen or air and 80 vol % to 90 vol % of an inert gas.

A disintegration process may be further performed between the primary heat treatment and the secondary heat treatment. Through this disintegration process, a particle aggregation phenomenon is further resolved, so that a high-density and long-lifespan lithium secondary battery may be manufactured.

As utilized herein, the “disintegration” is generally performed utilizing equipment such as a cutter mill, roll crusher, and ball mill to remove weak agglomeration between secondary particles. This disintegration process is carried out through dispersion to an appropriate or suitable size utilizing a rotary impact mill, a cutter mill, a ball mill, or a bead mill, each being provided with a built-in classification device such as a screen. As utilized herein, “disintegration” refers to a process of dispersing a material aggregated with a relatively weak force, such as a particle aggregate or a granulated product.

According to one or more embodiments, the disintegration is carried out at a rotation speed of about 100 rpm to about 300 rpm, about 100 rpm to about 250 rpm, or about 120 rpm to about 275 rpm utilizing roll crushers. The interval between the roll crushers is about 1 mm to about 3 mm, about 1.2 mm to about 2.8 mm, or about 1.5 mm. Stirring time for the disintegration is changed depending on disintegration conditions, but the disintegration is generally performed for about 10 seconds to about 60 seconds.

Examples of the cobalt precursor utilized when forming a cobalt compound-containing coating layer include cobalt hydroxide, cobalt sulfate, cobalt alkoxide, cobalt oxalate, cobalt phosphate, cobalt halide, cobalt oxyhalide, cobalt sulfide, cobalt oxide, cobalt peroxide, cobalt acetate, cobalt nitrate, cobalt carbonate, cobalt citrate, cobalt phthalate, cobalt perchlorate, and/or combinations thereof. For example, the cobalt precursor may include at least one of (e.g., one compound selected from) Co₃O₄, Co(OH)₂, CoO, CoOOH, Co(OCOCH₃)₂·4H₂O, Co(NO₃)₂·6H₂O, and/or Co(SO₄)₂·7H₂O.

The content (e.g., amount) of the cobalt precursor is stoichiometrically controlled or selected such that the content (e.g., amount) of a cobalt compound contained in the cobalt compound-containing coating layer may be about 0.1 mol % to about 5.0 mol % (e.g. about 0.5 mol % to about 5.0 mol %) based on the total content (e.g., amount) of the cathode active material.

The mixing of the nickel-based metal precursor and the lithium precursor may be dry mixing, and may be performed utilizing a mixer and/or the like. The dry mixing may be performed utilizing milling. Milling conditions are not particularly limited, but the mixing may be carried out such that there is little deformation such as micronization of the precursor utilized as a starting material. The size of the lithium precursor mixed with the nickel-based metal precursor may be controlled or selected in advance. The size (average particle diameter or size) of the lithium precursor is in the range of about 5 μm to about 15 μm, for example, about 10 μm. A required mixture may be obtained by milling the lithium precursor having this size and the nickel-based metal precursor at a rotation speed of about 300 rpm to about 3,000 rpm. When the internal temperature of the mixer rises to 30° C. or higher during the milling process, a cooling process may be performed to maintain the internal temperature of the mixer within a range of room temperature (25° C.).

The nickel-based metal precursor is, for example, Ni_{0.92}Co_{0.06}Mn_{0.02}(OH)₂, Ni_{0.92}Co_{0.05}Al_{0.03}(OH)₂, Ni_{0.94}Co_{0.03}Al_{0.03}(OH)₂, Ni_{0.88}Co_{0.06}Al_{0.06}(OH)₂, Ni_{0.96}Co_{0.02}Al_{0.02}(OH)₂, Ni_{0.93}Co_{0.04}Al_{0.03}(OH)₂, Ni_{0.8}Co_{0.15}Al_{0.05}(OH)₂, Ni_{0.75}Co_{0.20}Al_{0.05}(OH)₂, Ni_{0.92}Co_{0.05}Mn_{0.03}(OH)₂, Ni_{0.94}Co_{0.03}Mn_{0.03}(OH)₂, Ni_{0.88}Co_{0.06}Mn_{0.06}(OH)₂, Ni_{0.96}Co_{0.02}Mn_{0.02}(OH)₂, Ni_{0.93}Co_{0.04}Mn_{0.03}(OH)₂, Ni_{0.8}Co_{0.15}Mn_{0.05}(OH)₂, Ni_{0.75}Co_{0.20}Mn_{0.05}(OH)₂, Ni_{0.6}Co_{0.2}Mn_{0.2}(OH)₂, Ni_{0.7}Co_{0.15}Mn_{0.15}(OH)₂, Ni_{0.7}Co_{0.1}Mn_{0.2}(OH)₂, Ni_{0.8}Co_{0.1}Mn_{0.1}(OH)₂, or Ni_{0.85}Co_{0.1}Al_{0.05}(OH)₂.

The nickel-based lithium metal oxide according to one or more embodiments is, for example, LiNi_{0.92}Co_{0.06}Mn_{0.02}O₂, Li_{1.05}Ni_{0.92}Co_{0.05}Al_{0.03}O₂, Li_{1.05}Ni_{0.94}Co_{0.03}Al_{0.03}O₂, Li_{1.05}Ni_{0.88}Co_{0.06}Al_{0.06}O₂, Li_{1.05}Ni_{0.96}Co_{0.02}Al_{0.02}O₂, Li_{1.05}Ni_{0.93}Co_{0.04}Al_{0.03}O₂, Li_{1.05}Ni_{0.8}Co_{0.15}Al_{0.05}O₂, Li_{1.05}Ni_{0.75}Co_{0.20}Al_{0.05}O₂, Li_{1.05}Ni_{0.92}Co_{0.05}Mn_{0.03}O₂, Li_{1.05}Ni_{0.94}Co_{0.03}Mn_{0.03}O₂, Li_{1.05}Ni_{0.88}Co_{0.06}Mn_{0.06}O₂, Li_{1.05}Ni_{0.96}Co_{0.02}Mn_{0.02}O₂, Li_{1.05}Ni_{0.93}Co_{0.04}Mn_{0.03}O₂, Li_{1.05}Ni_{0.8}Co_{0.15}Mn_{0.05}O₂, Li_{1.05}Ni_{0.75}Co_{0.20}Mn_{0.05}O₂, Li_{1.05}Ni_{0.6}Co_{0.2}Mn_{0.2}O₂, Li_{1.05}Ni_{0.7}Co_{0.15}Mn_{0.15}O₂, Li_{1.05}Ni_{0.7}Co_{0.1}Mn_{0.2}O₂, Li_{1.05}Ni_{0.8}Co_{0.1}Mn_{0.1}O₂, or Li_{1.05}Ni_{0.85}Co_{0.1}Al_{0.5}O₂.

According to one or more embodiments, there is provided a cathode for lithium secondary battery including a cathode current collector, the above-described cathode active material, and at least one of (e.g., one selected from) large particles and/or crystal particles having the same composition as the cathode active material and aggregates thereof.

The cathode according to one or more embodiments may include, for example, the above-described cathode active material and large particles or crystal particles having the same composition as the cathode active material.

As utilized herein, the “large particle” refers to a monolithic structure in which particles are not aggregated with each other as a morphology phase and exist as an independent phase, and may be a particle that exists alone without having a grain boundary therein and is composed of one particle. The large particle may be a single crystal or a polycrystalline particle including several crystals. The large particle may be a monolithic particle. The large particles may represent a product obtained by partially crushing or breaking the nickel-based lithium metal oxide secondary particle during cathode pressing, and not the nickel-based lithium metal oxide secondary particle itself, which is a starting material utilized when forming the cathode active material layer.

The cathode active material of the cathode according to one or more embodiments contains pores having a size of about 0.5 μm to about 4 μm or about 0.5 μm to about 2 μm. The size of the pores may be confirmed through SEM analysis.

After the cathode is pressed, the cathode active material is disintegrated, and thus the aggregated primary particles are dispersed to manufacture a crystal cathode plate. The pores are, for example, closed pores. The density of the electrode after pressing is 3.3 g/cc or more.

The cathode includes a cathode active material layer having a structure in which particles are broken by being pressed more on the surface thereof than the central portion thereof adjacent to the cathode current collector. For example, a greater amount of large particles may be included in a surface portion of the cathode than in a central portion of the cathode, the central portion being adjacent to the cathode current collector. The reason why the cathode active material layer has the above-described structure is because the cathode active material layer is pressed more on the surface thereof than the central portion thereof adjacent to the cathode current collector. The structure of the cathode active material layer may be evaluated based on the area of an image through SEM and/or the like.

The size of the cathode active material at the central portion is about 1 μm to about 7 μm, and the size of the cathode active material at the surface portion is about 1 μm to about 5 μm.

The cathode includes a cathode active material layer having a structure in which the central portion thereof adjacent to the cathode current collector further includes a hollow cathode active material having a hollow structure as compared with the surface portion thereof. For example, a larger amount of a cathode active material having a hollow structure may be included in a central portion of the cathode than in a surface portion of the cathode, the central portion being adjacent to the cathode current collector. The structure of the cathode active material layer may be evaluated based on the area of an image through SEM and/or the like. The size of the pores of the cathode active material in the cathode after pressing may be different from the size of the pores of the cathode active material in the cathode before pressing.

The cathode according to one or more embodiments may include, for example, a cathode active material layer within two layers. The structure of the cathode active material layer may be confirmed through SEM, TEM, and/or the like.

As utilized herein, the “surface portion” indicates a region of the cathode active material layer far (distal) from the cathode current collector (substrate), and refers to a region (b) of 30% by length to 50% by length, for example 40% by length, from the outermost surface of the cathode active material layer or a region within about 20 μm from the outermost surface of the cathode active material layer (when the total thickness of the cathode active material layer is about 40 μm).

The “central portion” indicates a region of the cathode active material layer adjacent (proximal) to the cathode current collector (substrate), and refers to a region of 50% by length to 70% by length, for example, 60% by length from the center of the total length from the cathode current collector to the outermost surface of the cathode active material layer, or refers to a remaining region excluding the region within about 20 μm (based on the total thickness of the cathode active material layer being about 40 μm) from the outermost surface of the nickel-based active material layer.

The cathode according to one or more embodiments may be manufactured without performing a pulverization process of the cathode active material, so that productivity may be improved.

A lithium secondary battery according to one or more embodiments includes the above-described cathode, an anode, and an electrolyte between the cathode and the anode.

When the method of preparing a cathode active material according to one or more embodiments is utilized, it is possible to suppress or reduce aggregation between particles and improve productivity, as well as to manufacture a large particle (e.g., including or composed of large particles) or crystal cathode active material without a pulverization process. In one or more embodiments, when the cathode active material is utilized, it is possible to manufacture a lithium secondary battery having high density and improved lifespan.

Hereinafter, a method of manufacturing a lithium secondary battery, the battery including a cathode containing the cathode active material according to one or more embodiments, an anode, a lithium salt-containing non-aqueous electrolyte, and a separator, will be described.

The cathode and the anode are prepared by forming a cathode active material layer and an anode active material layer by applying and drying a composition for forming a cathode active material layer and a composition for forming an anode active material layer on current collectors, respectively.

The composition for forming a cathode active material layer is prepared by mixing a cathode active material, a conductive material, a binder, and a solvent. As the cathode active material, the nickel-based active material according to one or more embodiments is utilized.

The cathode binder serves to improve adhesion between cathode active material particles and adhesion force between the cathode active material and the cathode current collector. Specific examples of the cathode binder may include polyvinylidene fluoride (PVDF), vinylidene fluoride, hexafluoropropylene copolymer (PVDF-co-HFP), polyvinyl alcohol, polyacrylonitrile, carboxymethylcellulose (CMC), starch, hydroxypropylcellulose, recycled cellulose, polyvinylpyrrolidone, tetrafluoroethylene, polyethylene, polypropylene, ethylene-propylene-diene terpolymer (EPDM), sulfonated EPDM, styrene-butadiene rubber, fluorine rubber, and one or more suitable copolymers thereof. These binders may be utilized alone, and may be utilized as a mixture of two or more thereof.

The conductive material is not particularly limited as long as it has conductivity (e.g., is a conductor) without causing chemical changes to the battery, and examples thereof may include graphite such as natural graphite and/or artificial graphite; carbon-based materials such as carbon black, acetylene black, ketjen black, channel black, furnace black, lamp black, and/or thermal black; conductive fibers such as carbon fibers and/or metal fibers; carbon fluoride; metal powders such as aluminum powder and/or nickel powder; conductive whiskey such as zinc oxide and/or potassium titanate; conductive metal oxides such as titanium oxide; and conductive materials such as polyphenylene derivatives.

The content (e.g., amount) of the conductive material is 1 part by weight to 10 parts by weight or 1 part by weight to 5 parts by weight based on 100 parts by weight of the total weight of the cathode active material. When the content (e.g., amount) of the conductive material is within the above range, the finally obtained electrode has excellent or suitable conductivity properties.

A non-limiting example of the solvent may include N-methylpyrrolidone, and the content (e.g., amount) of the solvent is 20 parts by weight to 200 parts by weight based on 100 parts by weight of the cathode active material. When the content (e.g., amount) of the solvent is within the above range, the operation for forming an active material layer is facilitated.

The cathode current collector has a thickness of about 3 μm to about 500 μm, and is not particularly limited as long as it has high conductivity without causing chemical changes in the battery, and non-limiting examples thereof may include current collectors in which stainless steel, aluminum, nickel, titanium, heat-treated carbon, aluminum or stainless steel is surface-treated with carbon, nickel, titanium, and/or silver. The current collector may increase the adhesion force of the cathode active material by forming fine irregularities on its surface, and one or more suitable forms such as films, sheets, foils, nets, porous bodies, foams, and/or nonwoven fabrics are possible.

Separately, an anode active material, a binder, and a solvent are mixed to prepare a composition for forming an anode active material layer.

As the anode active material, a material capable of reversibly intercalating/deintercalating lithium ions, a lithium metal, an alloy of a lithium metal, a material capable of doping and dedoping lithium, transition metal oxide, or a combination thereof may be utilized.

Examples of the material capable of reversibly intercalating/deintercalating lithium ions may include carbon materials, that is, carbon-based anode active materials generally utilized in lithium secondary batteries. Examples of the carbon-based anode active material may include crystalline carbon, amorphous carbon, and/or a combination thereof. Examples of the crystalline carbon may include graphite such as shapeless, plate-like, flake-like, spherical and/or fibrous natural graphite and/or artificial graphite, and examples of the amorphous carbon include soft carbon or hard carbon, mesophase pitch carbide, and/or calcined coke.

As an alloy of the lithium metal, an alloy of lithium and a metal including (e.g., selected from) Na, K, Rb, Cs, Fr, Be, Mg, Ca, Sr, Si, Sb, Pb, In, Zn, Ba, Ra, Ge, Al and/or Sn may be utilized.

Example of the material capable of doping and dedoping lithium may include silicon-based materials such as Si, SiOx (0<x<2), and/or Si-Q alloys (Q is an element including (e.g., selected from) alkali metals, alkaline earth metals, Group 13 elements, Group 14 elements, Group 15 elements, Group 16 elements, metals, rare earth elements, and/or combinations thereof, not Si), Si—C composites, Sn, SnO₂, Sn—R (R is an element including (e.g., selected from) alkali metals, alkaline earth metals, Group 13 elements, Group 14 elements, Group 15 elements, Group 16 elements, metals, rare earth elements, and/or combinations thereof, not Sn), and Sn—C composites. In one or more embodiments, a mixture of SiO₂ and at least one of the above materials may be utilized. Q and R may include (e.g., may be selected from) Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and/or one or more combinations thereof.

Lithium titanium oxide may be utilized as the transition metal oxide.

Non-limiting examples of the anode binder may include one or more suitable types (kinds) of binder polymers such as polyvinylidene fluoride (PVDF), vinylidene fluoride, hexafluoropropylene copolymer (PVDF-co-HFP), polyvinyl alcohol, polyacrylonitrile, carboxymethylcellulose (CMC), starch, hydroxypropylcellulose, recycled cellulose, polyvinylpyrrolidone, tetrafluoroethylene, polyethylene, polypropylene, ethylene-propylene-diene terpolymer (EPDM), sulfonated EPDM, styrene-butadiene rubber, fluorine rubber, polyacrylic acid and polymers in which hydrogen of polyacrylic acid is substituted with Li, Na, or Ca, and/or one or more suitable copolymers thereof.

The anode active material layer may further include a thickener.

As the thickener, at least one of carboxymethyl cellulose (CMC), carboxyethyl cellulose, starch, regenerated cellulose, ethyl cellulose, hydroxymethyl cellulose, hydroxyethyl cellulose, hydroxypropyl cellulose, or polyvinyl alcohol may be utilized, and for example, CMC may be utilized.

The content (e.g., amount) of the solvent is about 100 parts by weight to about 300 parts by weight based on 100 parts by weight of the anode active material. When the content (e.g., amount) of the solvent is within the above range, the operation for forming the anode active material layer is facilitated.

The anode active material layer does not need a conductive material when conductivity is ensured. The anode active material layer may further include a conductive material when desired or necessary. The conductive material is not particularly limited as long as it has conductivity (e.g., is a conductor) without causing chemical changes to the battery, and examples thereof may include graphite such as natural graphite and/or artificial graphite; carbon-based materials such as carbon black, acetylene black, ketjen black, channel black, furnace black, lamp black, and/or thermal black; conductive fibers such as carbon fibers and/or metal fibers; carbon fluoride; metal powders such as aluminum powder and/or nickel powder; conductive whiskey such as zinc oxide and potassium titanate; conductive metal oxides such as titanium oxide; and/or conductive materials such as polyphenylene derivatives. The conductive material may be carbon black, and in one or more embodiments, carbon black having an average particle diameter (or size) of several tens of nanometers.

When the anode active material layer contains the conductive material, the content (e.g., amount) of the conductive material is 0.01 parts by weight to 10 parts by weight, 0.01 parts by weight to 5 parts by weight, or 0.1 parts by weight to 2 parts by weight based on 100 parts by weight of the total weight of the anode active material layer.

The anode current collector is generally made to have a thickness of about 3 μm to about 500 μm. The anode current collector is not particularly limited as long as it has high conductivity without causing chemical changes in the battery, and non-limiting examples thereof may include current collectors in which stainless steel, aluminum, nickel, titanium, heat-treated carbon, aluminum and/or stainless steel is surface-treated with carbon, nickel, titanium, and/or silver, and/or a current collector made of an aluminum-cadmium alloy. Like the cathode current collector, the anode current collector may increase the adhesion force of the anode active material by forming fine irregularities on its surface, and one or more suitable forms such as films, sheets, foils, nets, porous bodies, foams, and/or nonwoven fabrics are possible.

A separator is interposed between the cathode and anode prepared according to the above processes.

The separator has a pore diameter (or size) of about 0.01 μm to about 10 μm and a thickness of about 5 μm to about 300 μm. For example, as the separator, an olefin-based polymer such as polypropylene or polyethylene; or a sheet or nonwoven fabric made of glass fiber is utilized. When a solid electrolyte such as a polymer is utilized as the electrolyte, the solid electrolyte may also serve as the separator.

The lithium salt-containing non-aqueous electrolyte includes a non-aqueous electrolyte and a lithium salt. As the non-aqueous electrolyte, a non-aqueous electrolyte solution, an organic solid electrolyte, an inorganic solid electrolyte, and/or the any other suitable non-aqueous electrolyte may be utilized.

Non-limiting examples of the non-aqueous electrolyte may include aprotic organic solvents such as N-methyl-2-pyrrolidinone, propylene carbonate, ethylene carbonate, butylene carbonate, dimethyl carbonate, diethyl carbonate, gamma-butyrolactone,1,2-dimethoxyethane, 2-methyl tetrahydrofuran, dimethyl sulfoxide, 1,3-dioxolane, N,N-formamide, N,N-dimethylformamide, dioxolane, acetonitrile, nitromethane, methyl formate, methyl acetate, phosphoric acid triesters, trimethoxy methane, dioxolane derivatives, sulfolane, methyl sulfolane, 1,3-dimethyl-2-imidazolidinone, propylene carbonate derivatives, tetrahydrofuran derivatives, ethers, methyl pyropionate, and/or ethyl propionate.

Non-limiting examples of the organic solid electrolyte may include polyethylene derivatives, polyethylene oxide derivatives, polypropylene oxide derivatives, phosphoric ester polymer, polyester sulfide, polyvinyl alcohol, and/or polyvinylidene fluoride.

Non-limiting examples of the inorganic solid electrolyte may include nitrides, halogenides and sulfates of lithium (Li) such as Li₃N, LiI, Li₅Ni₂, Li₃N—LiI—LiOH, LiSiO₄, Li₂SiS₃, Li₄SiO₄, Li₄SiO₄—LiI—LiOH, and/or Li₃PO₄—Li₂S—SiS₂.

Non-limiting examples of the lithium salt, as materials easily soluble in the non-aqueous electrolyte, may include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, (FSO₂)₂NIi, lithium chloroborate, and/or combinations thereof.

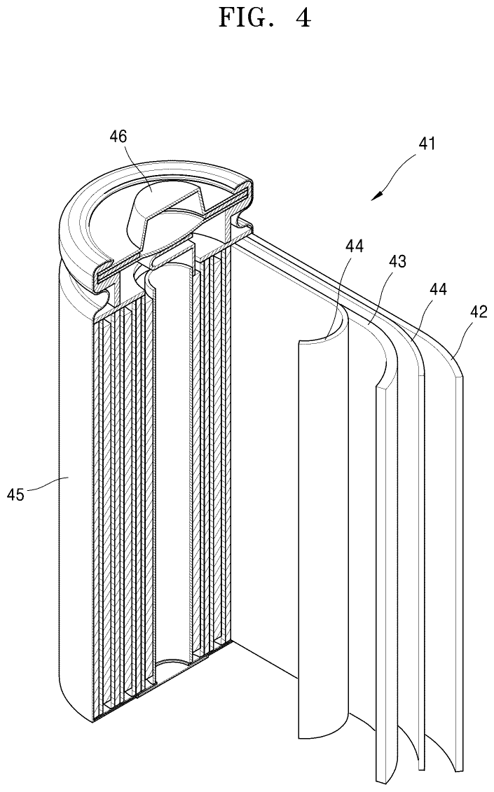

FIG. 4 is a schematic perspective view illustrating the structure of a lithium secondary battery according to one or more embodiments of the present disclosure.

Referring to FIG. 4, a lithium secondary battery 41 includes a cathode 43 according to one or more embodiments, an anode 42, and a separator 44. An electrode assembly in which the cathode 43, the anode 42, and the separator 44 are wound or folded is accommodated in a battery case 45. The separator 44 may be disposed between the cathode 43 and the anode 42 to form each cell structure, and these cell structures are stacked. Subsequently, an organic electrolyte is injected into the battery case 45, and the battery case is sealed with a cap assembly 46 to complete the lithium secondary battery 41. The battery case 45 may be a cylindrical case, a rectangular case, a thin film case, and/or any other suitable battery case. For example, the lithium secondary battery 41 may be a large thin film battery. The lithium secondary battery may be a lithium-ion battery After the cell structure is accommodated in a pouch, this cell structure is impregnated with an organic electrolyte, and sealed to complete a lithium-ion polymer battery. In one or more embodiments, the plurality of cell structures are stacked to form a battery pack, and this battery pack may be utilized in all appliances requiring high capacity and high output. For example, this battery pack may be utilized in notebooks, smart phones, electric vehicles, and/or the like.

In one or more embodiments, because the lithium secondary battery has excellent or suitable storage stability, lifetime characteristics, and high-rate characteristics at high temperatures, it may be utilized in electric vehicles (EV). For example, the lithium secondary battery may be utilized in hybrid vehicles such as plug-in hybrid electric vehicles (PHEV).

The present disclosure will be described in more detail with reference to the following Examples and Comparative Examples. However, these Examples are set forth to illustrate the present disclosure, and the scope of the present disclosure is not limited thereto.

### Preparation of Nickel-Based Metal Precursor

### Preparation Example 1

A nickel-based metal precursor (Ni_{0.92}Co_{0.06}Mn_{0.02}(OH)₂ was synthesized through co-precipitation.

Nickel sulfate (NiSO₄·6H₂O), cobalt sulfate (CoSO₄·7H₂O), and manganese sulfate (MnSO₄·H₂O) were dissolved in distilled water as a solvent in a molar ratio of Ni:Co:Mn=92:6:2 to prepare a metal raw material mixed solution. In order to produce a complex compound, a dilute aqueous ammonia (NH₄OH) solution and sodium hydroxide (NaOH) were prepared. Thereafter, the metal raw material mixed solution, aqueous ammonia, and sodium hydroxide were put into a reactor to obtain a mixture. Sodium hydroxide was added to maintain the pH in the reactor.

After the pH of the mixture was adjusted to a pH of 11.7 and the mixture was stirred for 10 hours, the pH of the mixture was adjusted to 11.5 to decrease the pH by about 0.2 based on initial pH, so that a co-precipitation rate was changed to cause a difference in synthesis rate between the inside and outside of the nickel-based metal precursor, thereby obtaining a nickel-based metal precursor having pores therein.

After the reaction was carried out for about 20 hours while stirring the reaction mixture, the addition of the metal raw material mixed solution was stopped.

The slurry solution in the reactor was filtered, washed with high-purity distill water, and then dried in a hot air oven at 200° C. for 24 hours to obtain a hollow-structure nickel-based metal precursor (Ni_{0.92}Co_{0.06}Mn_{0.02}(OH)₂) having pores therein. The nickel-based metal precursor is secondary particles each being aggregates of primary particles, and the average particle diameter (or size) of the secondary particles is about 14 μm.

### Comparative Preparation Example 1

A nickel-based metal precursor (Ni_{0.92}Co_{0.06}Mn_{0.02}(OH)₂ not having a hollow structure was obtained in substantially the same manner as in Preparation Example 1, except that the pH of the mixture was maintained at 11.7 without change instead of adjusting the pH of the mixture to 11.7 and stirring the mixture for 10 hours and then adjusting the pH of the mixture to 11.5 to decrease the pH by about 0.2 based on the initial pH.

### Preparation of Cathode Active Material for Lithium Secondary Batteries

### Example 1

Lithium carbonate was added to the hollow-structure nickel-based metal precursor (Ni_{0.92}Co_{0.06}Mn_{0.02}(OH)₂) of Preparation Example 1 to obtain a first mixture. The mixing molar ratio (Li/M) of lithium and metal in the first mixture is about 1.04. Here, the metal content (e.g., amount) M is a total content (e.g., amount) of Ni, Co and Mn. The mixture was subjected to primary heat treatment at 900° C. for 15 hours under an air atmosphere.

The primary heat treatment product was disintegrated utilizing a roll crusher (interval: 0.1 mm), and then disintegrated through a colloidal mill (interval <100 μm) to make a product having a particle size of about 13 μm to about 14 μm.

A cobalt precursor (Co(OH)₂) was added to the product disintegrated according to the above process, and secondary heat treatment was carried out at about 770° C. under an oxygen atmosphere to prepare a cathode active material (LiNi_{0.92}Co_{0.06}Mn_{0.02}O₂) having a hollow structure and including a cobalt compound-containing coating layer. The content (e.g., amount) of the cobalt precursor was controlled or selected such that the content (e.g., amount) of a cobalt compound in the cobalt compound-containing coating layer was 2 mol % based on the total content (e.g., amount) of the cathode active material.

The cathode active material obtained according to Example 1 had a state of secondary particles, each being an aggregate of primary particles. The size of the primary particles was about 3.5 μm, the average particle diameter (or size) of the secondary particles was about 13 μm, and each of the secondary particles had pores having a size of 3 μm therein. The content (e.g., amount) of the cobalt compound is 2 mol % based on the total content (e.g., amount) of the finally-obtained cathode active material, and the thickness of the coating layer is about 20 nm.

### Comparative Example 1

Lithium carbonate was added to the hollow-structure nickel-based metal precursor (Ni_{0.92}Co_{0.06}Mn_{0.02}(OH)₂)) of Preparation Example 1 to obtain a first mixture. The mixing molar ratio (Li/M) of lithium and metal in the first mixture is about 1.04. Here, the metal content (e.g., amount) M is a total content (e.g., amount) of Ni, Co and Mn. The mixture was subjected to primary heat treatment at 900° C. for 15 hours under an air atmosphere.

The primary heat treatment product obtained according to the above process was pulverized utilizing a Hosogawa jet mill (Blower 35 Hz, AFG 8000 rpm, Air 4 kgf/cm2) to prepare a nickel-based lithium metal oxide having a non-hollow structure.

A cobalt precursor (Co(OH)₂) was added to the nickel-based lithium metal oxide having a non-hollow structure, and secondary heat treatment was carried out at about 770° C. under an oxygen atmosphere to prepare a cathode active material (particle size: 3 μm to 4 μm) having a non-hollow structure.

### Comparative Example 2

A nickel-based lithium metal oxide having a non-hollow structure and a cathode active material having a non-hollow structure were prepared in substantially the same manner as in Comparative Example 1, except that the secondary heat treatment was not performed.

For the cathode active materials prepared according to Comparative Examples 1 and 2, a pulverization process utilizing a jet mill is additionally performed as an essential process, and the nickel-based lithium metal oxide having a non-hollow structure obtained after pulverization showed a small-grained crystal form having a size of about 3 μm to about 4 μm. These small-grained crystals have poor flow characteristics of powder, so manufacturing processability in mass production is poor. In addition, the cathode active materials prepared according to Comparative Examples 1 and 2 had a form of pulverized primary particles, but had many surface defects and showed a shape in which particles were broken. The surface defects are caused by the pulverization process.

In contrast, because the cathode active material of Example 1 maintains a large-grain form, its specific surface area is small, and its flowability is excellent or suitable, so its mass production processability is improved, as compared with the case of utilizing the cathode active materials of Comparative Examples 1 and 2.

### Examples 2 to 7, Comparative Example 2-1, and Comparative Example 2-2

Cathode active materials were prepared in substantially the same manner as in Example 1, except that preparation processes were changed according to the reaction conditions shown in Table 1 so as to obtain the cathode active material as shown in Table 1.

TABLE 1

| | Cathode active material | | | |
|---|---|---|---|---|
| | Primary | Secondary | | |
| | particle size | particle size | Inner pore size | Reaction |
| Class. | (μm) | (μm) | (μm) | condition |
| Example 1 | 3.5 | 13 | 3 | Primary heat treatment: |
| | | | | 900° C. |
| | | | | Secondary heat treatment: |
| | | | | 770° C. |
| Example 2 | 2 | 15 | 5 | Same as Example 1 |
| | | | | except that primary heat |
| | | | | treatment temperature was |
| | | | | changed to 870° C. |
| Example 3 | 6 | 15 | 5 | Same as Example 1 |
| | | | | except that primary heat |
| | | | | treatment temperature was |
| | | | | changed to 930° C. |
| Example 4 | 3.5 | 10 | 5 | Same as Example 1 |
| | | | | except that size of nickel- |
| | | | | based metal precursor was |
| | | | | changed to 11 μm |
| Example 5 | 3.5 | 18 | 5 | Same as Example 1 |
| | | | | except that size of nickel- |
| | | | | based metal precursor was |
| | | | | changed to 19 μm. |
| Example 6 | 3.5 | 15 | 2 | Same as Example 1 |
| | | | | except that inner pore size |
| | | | | of nickel-based metal |
| | | | | precursor is smaller than |
| | | | | that of Example 1 |
| Example 7 | 3.5 | 15 | 7 | Same as Example 1 |
| | | | | except that inner pore size |
| | | | | of nickel-based metal |
| | | | | precursor is larger than |
| | | | | that of Example 1 |
| Comparative | 0.5 | 3 | 0 | Same as Example 1 |
| Example 2-1 | | | | except that pulverization |
| | | | | was performed at higher |
| | | | | pressure than jet mill |
| | | | | conditions of Comparative |
| | | | | Example 1 |
| Comparative | 5 | 5 | 0 | Same as Example 1 |
| Example 2-2 | | | | except that pulverization |
| | | | | was performed at lower |
| | | | | pressure than jet mill |
| | | | | conditions of Comparative |
| | | | | Example 1 |

### Comparative Example 3

A nickel-based lithium metal oxide including crystal particles and having a hollow structure and a cathode active material were prepared in substantially the same manner as in Example 1, except that primary heat treatment was performed at 770° C. and secondary heat treatment was performed at 900° C.

When a cathode active material was prepared according to Comparative Example 3, secondary heat treatment was performed at a higher temperature than that of primary heat treatment. As a result, in the obtained cathode active material, crystals grew less and cation mixing characteristics were poor, compared to the cathode active material of Example 1. When a cathode active material was prepared according to Comparative Example 3, because secondary heat treatment is performed at 900° C., it was not easy for Ni to form a layered structure, so a large amount of Ni was phase-transitioned to a spinel or cubic phase, and cobalt added in the form of cobalt hydroxide was not applied on the surface but diffused into particles. As a result, the cathode active material of Comparative Example 3 had very different crystal properties compared to the cathode active material of Example 1.

### Comparative Example 4 (Pore-Free Nickel-Based Metal Precursor was Utilized as Starting Material)

A cathode active material was prepared in substantially the same manner as in Example 1, except that the nickel-based metal precursor (Ni_{0.92}Co_{0.06}Mn_{0.02}(OH)₂) having no hollow structure obtained according to Comparative Preparation Example 1 was utilized instead of the nickel-based metal precursor having a hollow structure of Preparation Example 1.

When primary heat treatment was performed according to Comparative Example 4, as compared with Example 1, a cathode active material having no hollow structure therein and having dense primary particles was prepared.

### Examples 8 and 9

Cathode active materials were prepared in substantially the same manner as in Example 1, except that the contents of the cobalt precursor were controlled or selected such that the contents of a cobalt compound in the cobalt compound-containing coating layer were 0.1 mol % and 5.0 mol %, respectively, based on the total content (e.g., amount) of the cathode active material.

### Manufacture Example 1: Manufacture of Coin Cell

A coin cell was manufactured as follows utilizing the cathode active material (LiNi_{0.92}Co_{0.06}Mn_{0.02}O₂) obtained according to Example 1 without a separate pulverization process.

A mixture of 96 g of the cathode active material (LiNi_{0.92}Co_{0.06}Mn_{0.02}O₂) obtained according to Example 1, 2 g of polyvinylidene fluoride, 47 g of N-methylpyrrolidone as a solvent, and 2 g of carbon black as a conducting agent was defoamed utilizing a mixer to prepare a uniformly dispersed slurry for forming a cathode active material.

The slurry prepared in this way was applied onto an aluminum foil utilizing a doctor blade to make a thin plate, and then this thin plate was dried at 135° C. for 3 hours or more and subjected to pressing and vacuum drying to manufacture a cathode.

A 2032 type coin cell was manufactured utilizing the cathode and a lithium metal electrode as a counter electrode. A separator (thickness: about 16 μm) made of a porous polyethylene (PE) film was interposed between the cathode and the lithium metal electrode, and an electrolyte was injected to prepare a 2032 type coin cell. As the electrolyte, a solution containing 1.1M LiPF₆ dissolved in a solvent in which ethylene carbonate (EC) and ethylmethyl carbonate (EMC) were mixed in a volume ratio of 3:5 was utilized.

When a coin cell is manufactured according to Manufacture Example 1, it is not necessary to undergo a pulverization process when manufacturing a cathode, and primary particles aggregated in the pressing process may be dispersed. Accordingly, productivity may be improved.

### Manufacture Examples 2 to 9: Manufacture of Coin Cells

Coin cells were manufactured in substantially the same manner as in Manufacture Example 1, except that each of the cathode active materials of Examples 2 to 9 was utilized instead of the cathode active material of Example 1.

### Comparative Manufacture Example 1: Manufacture of Coin Cell

A coin cell was manufactured in substantially the same manner as in Manufacture Example 1, except that the cathode active material (LiNi_{0.92}Co_{0.06}Mn_{0.02}O₂) obtained according to Comparative Example 1 was utilized as a cathode active material.

### Comparative Manufacture Example 2

A coin cell was manufactured in substantially the same manner as in Comparative Manufacture Example 1, except that the cathode active material of Comparative Example 2 was utilized instead of the cathode active material of Comparative Example 1.

### Comparative Manufacture Example 3

A coin cell was manufactured in substantially the same manner as in Comparative Manufacture Example 1, except that the cathode active material of Comparative Example 3 was utilized instead of the cathode active material of Comparative Example 1.

### Comparative Manufacture Example 4

A coin cell was manufactured in substantially the same manner as in Comparative Manufacture Example 1, except that the cathode active material of Comparative Example 4 was utilized instead of the cathode active material of Comparative Example 1.

### Evaluation Example 1: Scanning Electron Microscope

### (1) Example 1, Comparative Example 2 and Comparative Example 4

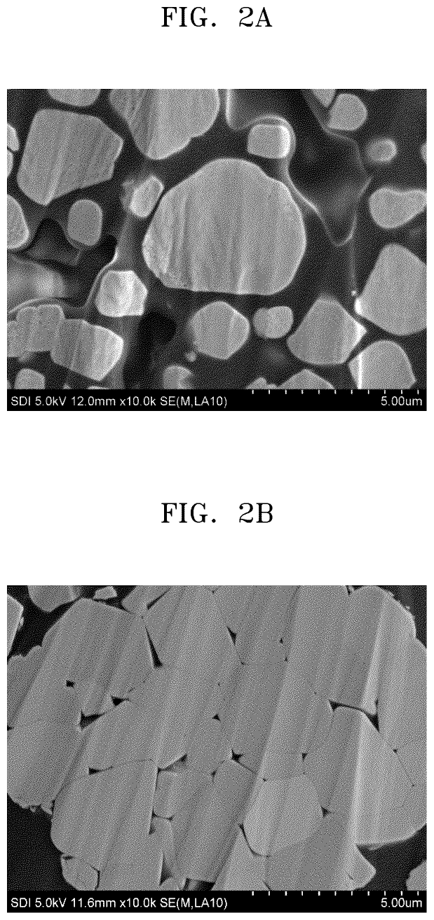

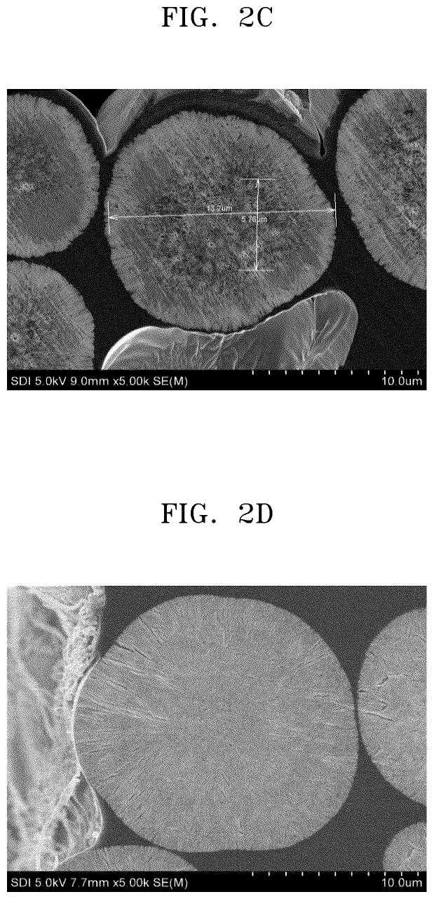

The cathode active materials of Example 1, Comparative Example 2, and Comparative Example 4 were subjected to scanning electron microscope analysis. Magellan 400L (FEI company) was utilized as a scanning electron microscope, and analysis results are shown in FIG. 1A and FIGS. 2A and 2B.

FIG. 1A is a scanning electron microscope (SEM) image of a cross-section of the cathode active material of Example 1, FIG. 2A is a SEM image of a cross-section of the cathode active material of Comparative Example 2, and FIG. 2B is a SEM image of a cross-section of the cathode active material of Comparative Example 4.

Referring to FIG. 1A, the cathode active material of Example 1 has a large particle form (e.g., includes large particles or crystals), has a hollow structure having pores therein, and includes primary particles having a size of 3.5 μm and secondary particles having a size of 13 μm.

As shown in FIG. 2A, the cathode active material of Comparative Example 2 has a shape of small grains (1 μm to 5 μm) and no pores. The cathode active material of Example 1 is an aggregate (secondary particles) before the small particles (primary particles) of Comparative Example 2 are pulverized.

In contrast, although the cathode active material of Comparative Example 4 was crystal form as shown in FIG. 2B, it has a dense aggregate form without a hollow structure.

### (2) Preparation Example 1 and Comparative Preparation Example 1

The nickel-based metal precursors of Preparation Example 1 and Comparative Preparation Example 1 were was subjected to scanning electron microscope analysis, and analysis results thereof are shown in FIGS. 2C and 2D.

Referring to FIGS. 2C and 2D, the nickel-based metal precursor of Preparation Example 1 has pores therein and includes secondary particles having a size of 13.7 μm (about 14 μm). The inside where pores exist has a major axis length of about 5.76 μm, and shows an amorphous structure.

In contrast, as shown in FIG. 2D, the nickel-based metal precursor of Comparative Preparation Example 1 shows a structure having no pores therein, unlike the nickel-based metal precursor of Preparation Example 1.

### Evaluation Example 2

The D50s, BET (Brunauer, Emmett and Teller) specific surface areas, and repose angles of the cathode active materials of Example 1, Comparative Example 1 and Comparative Example 2 were measured and shown in Table 2.

In the repose angle, a method of measuring an angle at which powder is piled up is utilized. The repose angle was measured utilizing a PT-D type or kind powder tester (manufactured by Hosokawa Micron Corporation). For example, a funnel equipped with a nozzle having an inner diameter of 5 mm was provided utilizing a support such that the upper portion of the funnel is located at a position of 225 mm from a horizontal board and the lower portion of the nozzle is located at a position of 135 mm from the horizontal board. A powder collecting table was located at a position of 75 mm from the lower portion of the nozzle. While taking care not to vibrate, the cathode active material was injected into the funnel so that it does not volatilize, and the angle of a corner formed by a horizontal plane of an inclined plane of a conical powder layer formed on the powder collecting table was measured. The same experiment was repeated 3 times, and the average value of the measured angles is set as a repose angle.

TABLE 2

| | | BET specific surface | Repose |
|---|---|---|---|
| Class. | D50(um) | area (m²/g) | angle (°) |
| Example 1 | 13.8 | 0.203 | 27.5 |
| Comparative | 3.3 | 0.675 | 43.2 |
| Example 1 | | | |
| Comparative | 2.8 | 0.858 | 49.4 |
| Example 2 | | | |

As shown in Table 2, it may be found that compared to the cathode active materials of Comparative Examples 1 and 2, the cathode active material of Example 1 has a large D50, a small BET specific surface area, and a small repose angle, indicating that flowability is better.

### Evaluation Example 3: Analysis of State after Pressing During Manufacturing Cathode

In order to compare the particle sizes and pore presences after pressing in the cathodes of Manufacture Example 1 and Comparative Manufacture Example 4, scanning electron microscope analysis was performed.

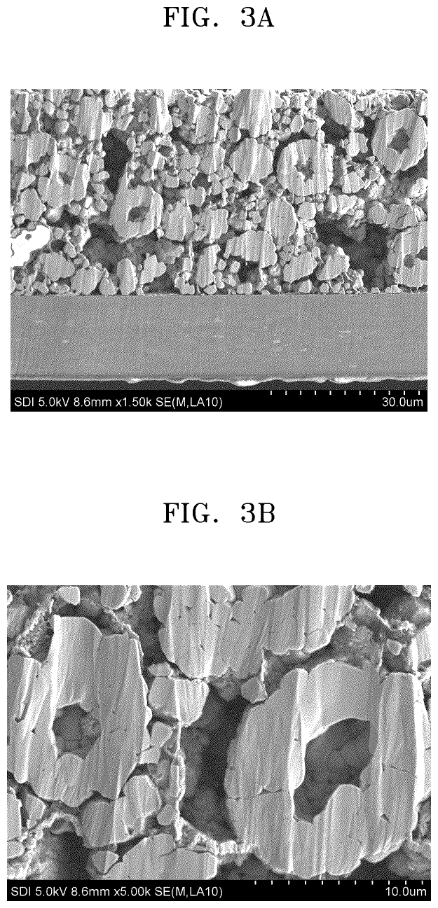

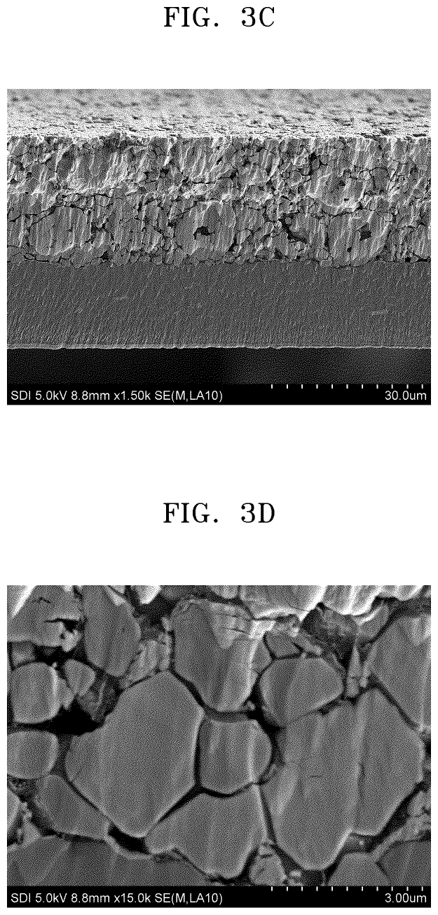

The scanning electron microscope analysis results are shown in FIGS. 3A and 3B. FIGS. 3A and 3B show the states before pressing when manufacturing the cathode of Manufacture Example 1. FIG. 3C shows a state after pressing during the process of manufacturing the cathode according to Manufacture Example 1, and FIG. 3D shows a state after pressing during the process of manufacturing the cathode according to Comparative Manufacture Example 4.

In the cathode of Manufacture Example 1, the cathode active material having pores is disintegrated and dispersed by pressing. As a result, as shown in FIG. 3C, the cathode active material layer has a two-layer structure and includes nickel-based metal oxide secondary particles each including a plurality of large primary particles as a cathode active material.

The cathode of Manufacture Example 1 includes a mixture of primary particles A and secondary particles B, which are aggregates of primary particles. It may be confirmed that pores exist in the cathode active material layer. The primary particles A are a plurality of large primary particles, and the secondary particle B shows a state in which the nickel-based lithium metal oxide secondary particle was partially crushed or broken by the pressing of the cathode.

In one or more embodiments, it may be found that, in the cathode active material layer, particles are broken by being pressed more at the surface portion thereof than the central portion thereof adjacent to the cathode current collector.

In the cathode manufactured according to Comparative Manufacture Example 4, the cathode active material of Comparative Example 4 having no hollow structure is utilized. As shown in FIG. 3D, in the cathode of Comparative Manufacture Example 4, unlike the cathode of Manufacture Example 1, the separation of secondary particles did not occur after pressing during the process of manufacturing a cathode, thereby indicating a state of the cathode very different from that of the cathode of Manufacture Example 1 (as shown, for example, in FIG. 3C). When the cathode of Comparative Manufacture Example 4 was utilized, electrochemical characteristics were poor compared to the case of Manufacture Example 1.

### Evaluation Example 4: X-Ray Diffraction Analysis

The cathode active material prepared according to Example 1 and the cathode active materials prepared according to Comparative Examples 1 to 3 were subjected to X-ray diffraction analysis utilizing X'pert pro (PANalytical) utilizing Cu Kα radiation (1.54056 Å), and the results are shown in Table 3.

In Table 3, I₍₀₀₃₎ refers to an intensity of the peak corresponding to the (003) plane (peak having 2θ of about 18° to about 19°), and I₍₁₀₄₎ refers to an intensity of the peak corresponding to the (104) plane (peak having 2θ of about 44.5°). In addition, FWHM(003) refers to full width at half maximum (FWHM) of the peak corresponding to the (003) plane, and FWHM₍₁₀₄₎ refers to full width at half maximum (FWHM) of the peak corresponding to the (104) plane. In Table 3, A₍₀₀₃₎ refers to an area of the peak corresponding to the (003) plane, and A₍₁₀₄₎ refers to an area of the peak corresponding to the (104) plane

TABLE 3

| | | FWHM₍₀₀₃₎/ | I₍₀₀₃₎/ | A₍₀₀₃₎/ |
|---|---|---|---|---|
| Class. | FWHM₍₀₀₃₎(°) | FWHM₍₁₀₄₎ | I₍₁₀₄₎ | A₍₁₀₄₎ |
| Example 1 | 0.0807 | 0.85 | 1.73 | 1.35 |
| Comparative | 0.0818 | 0.73 | 1.66 | 1.21 |
| Example 1 | | | | |
| Comparative | 0.0805 | 0.79 | 1.65 | 1.23 |
| Example 2 | | | | |
| Comparative | 0.0850 | 0.63 | 1.31 | 1.12 |
| Example 3 | | | | |

It was found that the cathode active material of Example 1 is a crystal from the FWHM₍₀₀₃₎ and FWHM₍₀₀₃₎/FWHM₍₁₀₄₎ characteristics of Table 3. In addition, it was found that the cathode active material of Example 1 did not undergo a pulverization process, so that it had less crystal damage to the cathode active material, and thus had superior crystal characteristics compared to Comparative Examples 1 to 3. The less crystal damage of the cathode active material may be confirmed from the above-described FWHM₍₀₀₃₎ and FWHM₍₀₀₃₎/FWHM₍₁₀₄₎ values. Generally, the lower the FWHM₍₀₀₃₎, the larger the crystal grains of the active material grew in the (003) direction with a substantially uniform crystal structure, and the higher the FWHM₍₀₀₃₎/FWHM₍₁₀₄₎ ratio, the crystal grains of the active material grew in the (104) direction with a substantially uniform crystal structure.

As may be found from Table 3, the cathode active material of Example 1 exhibited a level similar to the crystal characteristics of Comparative Example 2. When this cathode active material of Example 1 was utilized, the mixing ratio of cations was reduced compared to the cathode active materials of Comparative Examples 1 and 2, and thus high capacity was possible.

### Evaluation Example 5: Charge-Discharge Characteristics

In the coin cells manufactured according to Manufacture Example 1, Comparative Manufacture Example 1, Comparative Manufacture Example 2, and Comparative Manufacture Example 4, charge-discharge characteristics and the like were evaluated with a charger (manufacturer: TOYO, model: TOYO-3100).

In the first charge-discharge cycle, the coin cell was charged with a constant current of 0.1 C at 25° C. until a voltage reached 4.2 V, and was then charged with a constant voltage until the current reached 0.05 C. After the completely charged coin cell was subjected to a rest period of about 10 minutes, the coin cell was discharged with a constant current of 0.1 C until the voltage reached 3 V. In the second charge-discharge, the coin cell was charged with a constant current of 0.2 C until a voltage reached 4.2 V, and was then charged with a constant voltage until the current reached 0.05 C. After the completely charged coin cell was subjected to a rest period of about 10 minutes, the coin cell was discharged with a constant current of 0.2 C until the voltage reached 3 V.

For lifespan evaluation, the coin cell was charged with a constant current of 1 C until a voltage reached 4.2 V, and was then charged with a constant voltage until the current reached 0.05 C. After the completely charged coin cell was subjected to a rest period of about 10 minutes, the coin cell was discharged with a constant current of 0.2 C until the voltage reached 3 V. This cycle was repeated 50 times and evaluation was performed.

Capacity retention ratio (CRR) was calculated using Equation 2, and charge-discharge efficiency was calculated using Equation 3.

$$Equation 2$$

$$Capacity retention ratio [ \% ] = [ \text{} discharge capacity at {50}^{th} cycle / discharge capacity at {1}^{st} cycle ] \times 100$$

$$Equation 3$$

$$Charge - discharge efficiency [ \% ] = [ discharge voltage at {1}^{st} cycle / charge voltage at {1}^{st} cycle ] \times 100$$

The above-described capacity retention ratio and charge/discharge efficiency were evaluated and shown in Table 4.

TABLE 4

| | | Capacity |
|---|---|---|
| | Charge-discharge | retention |
| Class. | efficiency (%) | ratio (%) |
| Manufacture Example 1 | 88 | 94 |
| Comparative Manufacture | 89 | 95 |
| Example 1 | | |
| Comparative Manufacture | 89 | 94 |
| Example 2 | | |
| Comparative Manufacture | 87 | 89 |
| Example 4 | | |

Referring to Table 4, the coin cell manufactured according to Manufacture Example 1 has improved capacity retention and charge-discharge efficiency as compared to the coin cell of Comparative Manufacture Example 4 that has no pores and was not pulverized. In addition, as shown in Table 4, as can be seen from Table 4, the coin cell of Manufacture Example 1 has almost the same charge-discharge efficiency and capacity retention rate as compared to the coin cell of Comparative Manufacture Examples 1 and 2, but as shown in Table 2 above, the processibility (flowability) of particles is greatly improved compared to the coin cell of Comparative Manufacture Examples 1 and 2 in which pulverization is performed, so that mass production is facilitated.

### Evaluation Example 6: Energy Dispersive Spectroscopy (EDS) Analysis

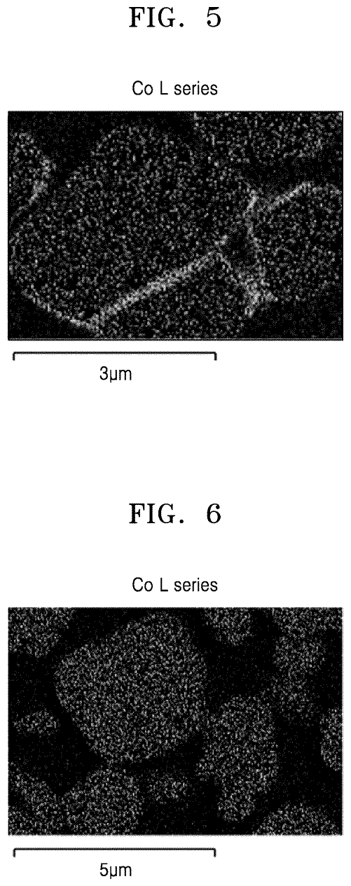

The concentration distributions of metal ions in the cathode active materials of Example 1 and Comparative Example 1 were measured by EDS, and the results are shown in FIGS. 5 and 6, respectively.

As shown in FIG. 5, it may be found that in the cathode active material of Example 1, cobalt is present in a higher concentration toward the surface thereof.

In contrast, as shown in FIG. 6, the cathode active material of Comparative Example 1 showed a substantially uniform distribution of cobalt as a whole. In the case of Comparative Example 1, because the surfaces of particles having a size of 3 μm to 4 μm are coated with cobalt after pulverization, it is easy for cobalt to penetrate from the surface to the inside, so that cobalt exhibits a substantially uniform distribution characteristic as a whole. In contrast, in the case of Example 1, because particles have a size of 13 μm, cobalt is present in a higher concentration toward the surface thereof compared to the Comparative Example 1.

When a cathode active material for lithium secondary batteries according to one or more embodiments is utilized, a pulverization process of the cathode active material may be omitted, aggregation between particles may be suppressed or reduced, productivity may be improved, and a cation mixing ratio may be reduced, so that a large particle nickel-based active material for lithium secondary batteries, capable of high capacity, may be manufactured. A lithium secondary battery manufactured utilizing such a cathode active material for lithium secondary batteries has improved charge-discharge efficiency and capacity retention.

The vehicle, the electronic device, and/or the battery, e.g., a battery controller, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the drawings, it will be understood by those of ordinary skill in the art that various changes in form and details may be made therein without departing from the spirit and scope of the disclosure as defined by the following claims and equivalents thereof.

What is claimed is:

1. A cathode active material for lithium secondary batteries, the cathode active material comprising:
nickel-based lithium metal oxide secondary particles each comprising a plurality of primary particles, the nickel-based lithium metal oxide secondary particles having a hollow structure having pores therein, and
a cobalt compound-containing coating layer on surfaces of the nickel-based lithium metal oxide secondary particles,
wherein a peak intensity ratio (I₍₀₀₃₎/I₍₁₀₄₎) of the cathode active material, is in a range of 1.2 to 4.0.

2. The cathode active material of claim 1, wherein at least one of the surfaces or grain boundaries of the plurality of primary particles comprises the cobalt compound-containing coating layer.

3. The cathode active material of claim 1, wherein a content of a cobalt compound in the cobalt compound-containing coating layer is about 0.1 mol % to about 5.0 mol % based on a total content of the cathode active material.

4. The cathode active material of claim 1, wherein the cobalt compound-containing coating layer has a thickness of about 1 nm to about 50 nm.

5. The cathode active material of claim 1, wherein, in the cobalt compound-containing coating layer, a cobalt compound is cobalt oxide, lithium cobalt oxide, or a combination thereof.

6. The cathode active material of claim 5, wherein the cobalt compound-containing coating layer further comprises at least one of boron, manganese, phosphorus, aluminum, zinc, zirconium, or titanium.

7. The cathode active material of claim 5, wherein the pores have a size of 0.5 μm to 4 μm.

8. The cathode active material of claim 1, wherein the nickel-based lithium metal oxide secondary particles comprise a compound represented by Formula 1 below: 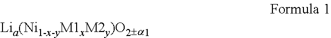
wherein in Formula 1, M1 is at least one of Co, Mn, of Al,
M2 is at least one of boron (B), magnesium (Mg), calcium (Ca), strontium (Sr), barium (Ba), titanium (Ti), vanadium (V), chromium (Cr), iron (Fe), copper (Cu)), or zirconium (Zr), and
0.95≤a≤1.1, 0.6≤(1−x−y)<1, 0≤x<0.4, 0≤y<0.4, and 0≤α1≤0.1, and wherein a case in which both x and y are 0 is excluded.

9. The cathode active material of claim 1, wherein the nickel-based lithium metal oxide secondary particles comprise a compound represented by Formula 2 below: 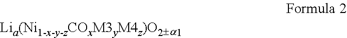
wherein in Formula 2, M3 is at least one of Mn or Al,
M4 is at least one of boron (B), magnesium (Mg), calcium (Ca), strontium (Sr), barium (Ba), titanium (Ti), vanadium (V), chromium (Cr), iron (Fe), copper (Cu), or zirconium (Zr), and
0.95≤a≤1.1, 0.6≤(1−x−y−z)<1, 0≤x<0.4, 0≤y<0.4, 0≤z<0.4, and 0≤α1≤0.1, and wherein a case in which all of x, y, and z are 0 is excluded.

10. The cathode active material of claim 1, wherein the plurality of primary particles have a size of about 2 μm to about 4 μm, and the nickel-based lithium metal oxide secondary particles have a size of about 12 μm to about 18 μm.

11. The cathode active material of claim 1, wherein an area ratio A₍₀₀₃₎/A₍₁₀₄₎ of the cathode active material, measured by X-ray diffraction analysis, is about 1.1 to about 1.4.

12. A method of preparing a cathode active material for lithium secondary batteries, the method comprising:
mixing a nickel precursor, at least one of an M1 precursor or an M2 precursor, and a basic solution to obtain a mixture,
subjecting the mixture to a co-precipitation reaction, and then drying the mixture to obtain a nickel-based metal precursor having pores therein;
obtaining a mixture of the nickel-based metal precursor having pores therein and a lithium precursor;
performing a primary heat treatment of the mixture to obtain a product of the primary heat treatment; and
adding a cobalt precursor to the product of the primary heat treatment without a pulverization process of the product, to obtain a mixture, and performing a secondary heat treatment of the mixture to prepare the cathode active material,
wherein the primary heat treatment is performed at a higher temperature than the secondary heat treatment,
the M1 precursor is at least one of a cobalt precursor, a manganese precursor, or an aluminum precursor,
the M2 precursor contains at least one of boron (B), magnesium (Mg), calcium (Ca), strontium (Sr), barium (Ba), titanium (Ti), vanadium (V), chromium (Cr), iron (Fe), copper (Cu), or zirconium (Zr), and
during the co-precipitation reaction, a pH of the mixture is adjusted in two steps, a second step is carried out at a lower pH than a first step, and a difference in pH between the first step and the second step is 0.1 to 1.5.

13. The method of claim 12, wherein the nickel-based metal precursor has a pore region therein, and a size of the pore region is about 2 μm to about 7 μm.

14. The method of claim 12, wherein the cobalt precursor is Co(OH)₂, CoOOH, CoO, Co₂O₃, Co₃O₄, Co(OCOCH₃)₂·4H₂O, CoCl₂, Co(NO₃)₂·6H₂O, CoSO₄, Co(SO₄)₂·7H₂O, or a combination thereof.

15. The method of claim 12, wherein the nickel-based metal precursor is a compound represented by Formula 3 below, a compound represented by Formula 4 below, or a combination thereof: 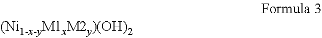
wherein, in Formula 3, M1 is at least one of Co, Mn, or Al,
M2 is at least one of boron (B), magnesium (Mg), calcium (Ca), strontium (Sr), barium (Ba), titanium (Ti), vanadium (V), chromium (Cr), iron (Fe), copper (Cu), of zirconium (Zr), and
0.6≤(1−x−y)<1, 0≤x<0.4, and 0≤y<0.4, and wherein a case in which both x and y are 0 is excluded, and 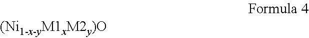
wherein, in Formula 4, M1 is at least one of Co, Mn, or Al,
M2 is at least one of boron (B), magnesium (Mg), calcium (Ca), strontium (Sr), barium (Ba), titanium (Ti), vanadium (V), chromium (Cr), iron (Fe), copper (Cu), or zirconium (Zr), and
0.6≤(1−x−y)<1, 0≤x<0.4, and 0≤y<0.4, and wherein a case in which both x and y are 0 is excluded.

16. The method of claim 12, wherein the nickel-based metal precursor is a compound represented by Formula 5 below, a compound represented by Formula 6 below, or a combination thereof: 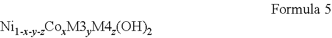
wherein, in Formula 5, M3 is at least one of Mn or Al,
M4 is at least one of boron (B), magnesium (Mg), calcium (Ca), strontium (Sr), barium (Ba), titanium (Ti), vanadium (V), chromium (Cr), iron (Fe), copper (Cu), or zirconium (Zr), and
0.6≤(1−x−y−z)<1, 0≤x<0.4, 0≤y<0.4, and 0≤z<0.4, and wherein a case in which all of x, y, and z are 0 is excluded, and 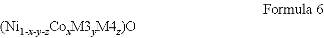
wherein, in Formula 6, M3 is at least one of Mn or Al,
M4 is at least one of boron (B), magnesium (Mg), calcium (Ca), strontium (Sr), barium (Ba), titanium (Ti), vanadium (V), chromium (Cr), iron (Fe), copper (Cu), or zirconium (Zr), and
0.6≤(1−x−y−z)<1, 0≤x<0.4, 0≤y<0.4, and 0≤z<0.4, and wherein a case in which all of x, y, and z are 0 is excluded.

17. The method of claim 12, wherein the nickel-based metal precursor and the lithium precursor are mixed such that a molar ratio of Li/Me, wherein Me is an element other than Li, O, and H, is 0.9 or more and less than 1.1.

18. The method of claim 12, wherein the lithium precursor is lithium hydroxide, lithium carbonate, lithium sulfate, lithium nitrate, or a combination thereof.

19. The method of claim 12, wherein the primary heat treatment is performed at a temperature of 800° C. to 1200° C. under an oxidizing gas atmosphere.

20. The method of claim 12, wherein the secondary heat treatment is performed at a temperature of 600° C. to 850° C. under an oxidizing gas atmosphere.

21. A cathode for lithium secondary batteries, the cathode comprising:
a cathode current collector, and
a cathode active material layer on the cathode current collector,
wherein the cathode active material layer comprises:
the cathode active material of claim 1; and
at least one of particles or aggregates thereof, the particles having the same composition as the cathode active material.

22. The cathode of claim 21, wherein the pores has a size in a range of 0.5 μm to 4 μm.

23. The cathode of claim 21, wherein a greater amount of the particles are in a surface portion of the cathode than in a central portion of the cathode, the central portion being adjacent to the cathode current collector.

24. The cathode of claim 21, wherein a larger amount the cathode active material comprising the secondary particles having the hollow structure are in a central portion of the cathode than in a surface portion of the cathode, the central portion being adjacent to the cathode current collector.

25. The cathode of claim 21, wherein the cathode active material layer has a single layer or two-layer structure.

26. A lithium secondary battery comprising:
the cathode of claim 21;
an anode; and
an electrolyte between the cathode and the anode.
